(19) United States
(12) Patent Application Publication
(10) Pub. No.: US 2010/0194141 A1
(43) Pub. Date: Aug. 5, 2010

(54) MULTI-SHADE VEHICLE WINDOW COVER

(75) Inventors: Jim R. Varney, Maynard, MA (US); John A. MacNeill, Acton, MA (US); Bryan R. Hotaling, Harvard, MA (US)

Correspondence Address: BARNES & THORNBURG LLP, 11 SOUTH MERIDIAN, INDIANAPOLIS, IN, 46204, US

(73) Assignee: Cosco Management, Inc., Wilmington, DE (US)

(21) Appl. No.: 12/365,814

(22) Filed: Feb. 4, 2009

(51) Int. Cl. B60J 3/00

(52) U.S. Cl. 296/152

(57) ABSTRACT

A vehicle window cover includes a window mount adapted to be mounted on a vehicle window and a roller shade coupled to the window mount.

### BACKGROUND

The present disclosure relates to window covers, and in particular to vehicle window covers. More particularly, the present disclosure relates to a vehicle window cover having a roller shade.

### SUMMARY

A vehicle window cover in accordance with the present disclosure includes a roller shade or other suitable shade. The roller shade includes a pliable window-cover mat wound on a mat-support pin. The window-cover mat is arranged to be unrolled as needed to create a sun shield on a vehicle window.

In illustrative embodiments, the roller shade is a lower shade and the vehicle window cover also includes an upper shade arranged to lie above the roller shade. The upper shade is located to block any sunlight that might stream through any gap located on the vehicle window above the roller shade and below a top portion of the vehicle window frame. The upper shade cooperates with the underlying lower shade to define an expanded sun shield on the vehicle window.

In illustrative embodiments, the vehicle window cover further includes a swivel positioned to lie between and to interconnect the upper shade and the lower shade. The swivel permits a user to rotate the upper shade about a pivot axis relative to the lower shade to cause the upper shade to assume a tilted position relative to the generally horizontal lower shade. The upper shade, when tilted, slopes in either an uphill (positive slope) or downhill (negative slope) direction to cover the gap between the window frame and the lower shade.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a multi-shade vehicle window cover for covering a vehicle window to block light from entering the vehicle window and for providing shade to an occupant inside the vehicle, the multi-shade vehicle window cover includes a lower shade designed to assume multiple user-selected vertical positions (as suggested by the vertical double phantom arrow), a swivel, and an upper shade including a window-cover plate and a pair of suction cups providing means for anchoring the window-cover plate to the vehicle window, and suggesting that the upper shade may be rotated relative to the lower shade in a counter-clockwise direction (shown in FIGS. 2 and 5) or a clockwise direction (shown in FIG. 6) about a pivot axis extending perpendicularly through the window-cover plate and the lower shade;

FIG. 2 is a perspective view of the multi-shade vehicle window cover of FIG. 1 showing that the vehicle window cover is illustratively coupled to a left-rear vehicle window and is configured to shade a juvenile sitting in a left-rear vehicle seat from light coming through the window and showing that the window-cover plate has been positioned at an angle relative to the lower shade to cover an un-shaded gap between the top of the horizontal lower shade and an overlying window frame of the vehicle window;

FIG. 3 is an exploded perspective view of the multi-shade vehicle window cover of FIG. 1 showing that the vehicle window cover includes, from the lower left to the upper right, a mat tether (suction cup), a pliable window-cover mat partly wound about a mat-support pin, a pin-support frame, a swivel including an axle-support plate, an axle comprising several journal posts coupled to the axle-support plate, and a pair of shade-mount fasteners, a window-cover plate formed to include a pivot receiver positioned in the lower center of the window-cover plate, a pair of suction cups, and a pivot retainer configured to secure the axle of the swivel to the window-cover plate;

FIG. 4 is an elevation view of the multi-shade vehicle window cover of FIGS. 1-3 suggesting that the window-cover plate may be rotated about the pivot axis in either the clockwise (FIG. 6) or the counter-clockwise (FIG. 5) directions as suggested by the two phantom arrows above the swivel;

FIG. 5 is a view similar to FIG. 4 showing that the multi-shade vehicle window cover is configured for use with a left-rear vehicle window and showing that the window-cover plate has been rotated about the pivot axis in the counter-clockwise direction (solid arrow);

FIG. 6 is a view similar to FIG. 5 showing that the multi-shade vehicle window cover is configured for use with a right-rear vehicle window and showing that the window-cover plate has been rotated about the pivot axis in the clockwise direction (solid arrow);

FIG. 7 is a sectional view taken along line 7-7 of FIGS. 1 and 4 showing that the swivel interconnects the lower shade and the upper shade to allow the lower shade to be rotated freely relative to the upper shade as illustrated in FIGS. 4-6 and showing that the swivel is coupled securely to the window-cover plate by a pivot retainer inserted into the axle of the swivel so as to lie between the journal posts impeding disassembly of the multi-shade vehicle window cover;

FIG. 8 is an enlarged partial exploded rear perspective view of the swivel of FIG. 3, showing that an axle included in the swivel is inserted through a pivot receiver formed in the window-cover plate and that the axle is held in place by a pivot retainer; and

FIG. 9 is an enlarged partial exploded front perspective view of the swivel of FIGS. 3 and 8, showing that the axle passes through an axle-receiver passageway defined by the pivot receiver and that the pivot retainer keeps the axle in rotative bearing engagement with the pivot receiver.

### DETAILED DESCRIPTION

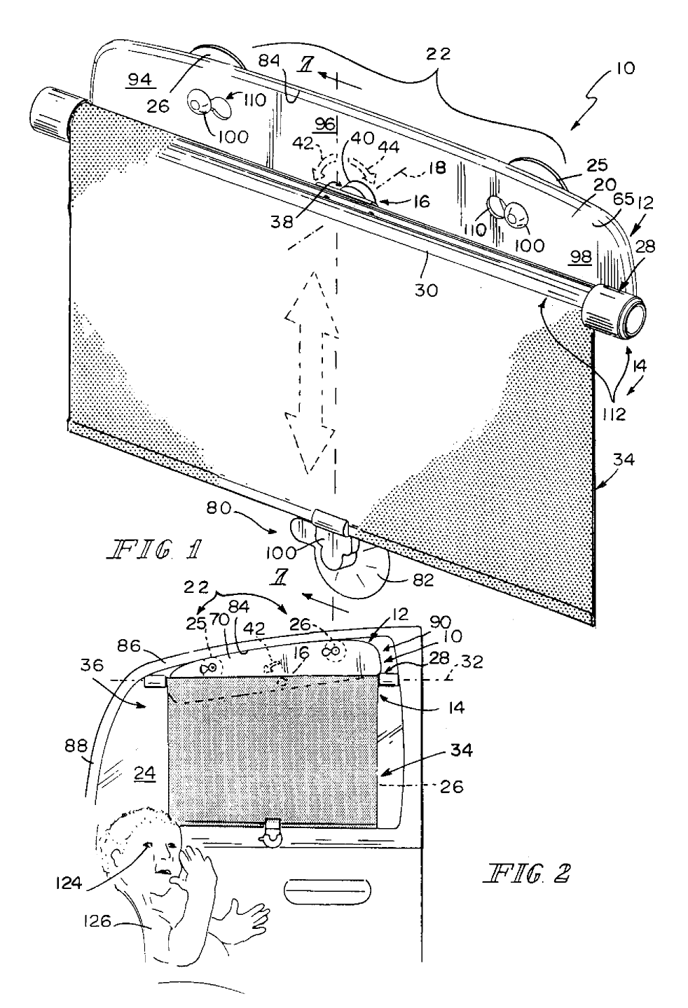

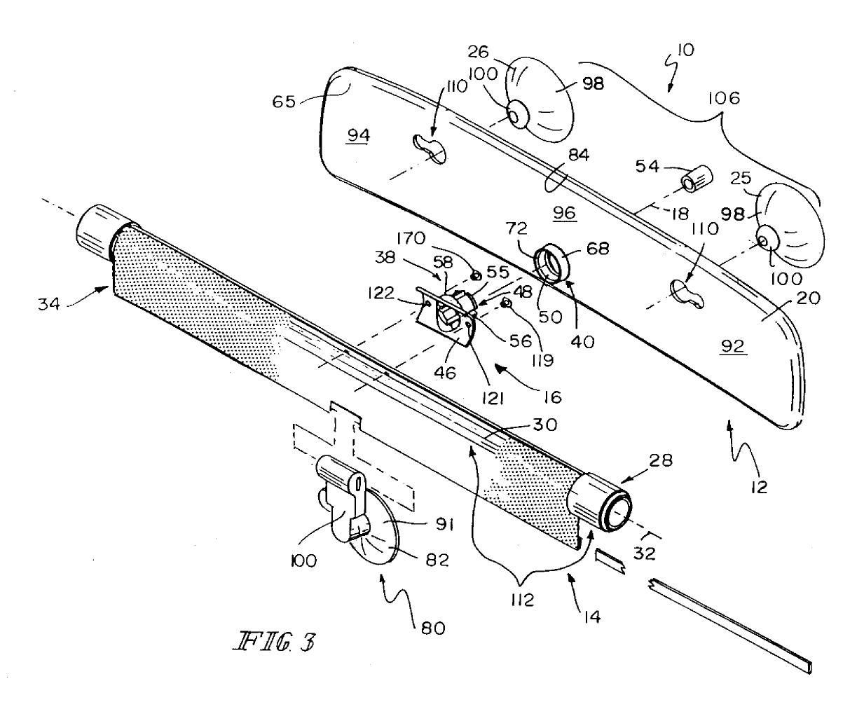

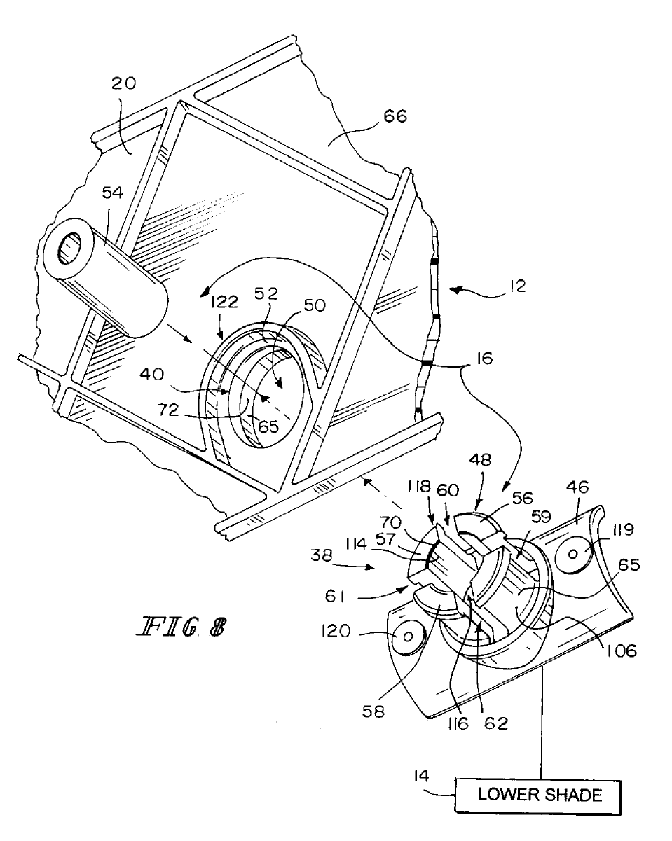

A multi-shade vehicle window cover 10, as illustrated in FIGS. 1 and 7, includes an upper shade 12, a lower shade 14, and a swivel 16 coupled to upper shade 12 and to lower shade 14. Swivel 16 is configured to support lower shade 14 for pivotable movement relative to upper shade 12 about a pivot axis 18 as suggested in FIGS. 2 and 4-6 to block sunlight that may stream through any gap 90 formed between lower shade 14 and overlying window frame 88.

As shown in FIG. 2, upper shade 12 includes a window-cover plate 20 and anchor means 22 for anchoring window-cover plate 20 to a vehicle window 24. In illustrative embodiments, anchor means 22 includes a first suction cup 25 and a second suction cup 26. First suction cup 25 is coupled to a right-side section 92 of window-cover plate 20 and second suction cup 26 is coupled to an opposite left-side section 94 of window-cover plate 20.

Lower shade 14 includes mat mount 112 and a pliable-window cover mat 34 coupled to mat mount 112 as suggested in FIG. 3 and shown in FIG. 7. Mat mount 112 includes a pin-support frame 28 coupled to swivel 16 and a mat-support pin 30 mounted on pin-support frame 28 for rotation about an axis of rotation 32. Window-cover mat 34 is coupled to mat-support pin 30 for movement between a rolled storage position (suggested in FIG. 3) wound about mat-support pin 30 and an unrolled use position (suggested in FIG. 2) arranged to hang downwardly from mat-support pin 30 in a direction extending away from upper shade 12. Pliable window-cover mat 34 cooperates with window-cover plate 20 to create an expanded sun shield 36 as shown in FIG. 2.

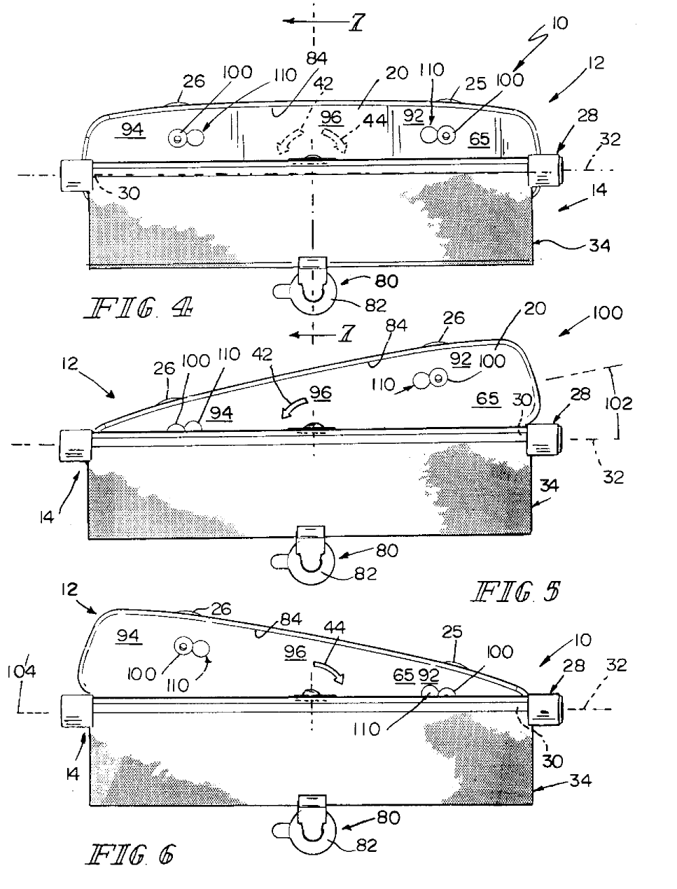

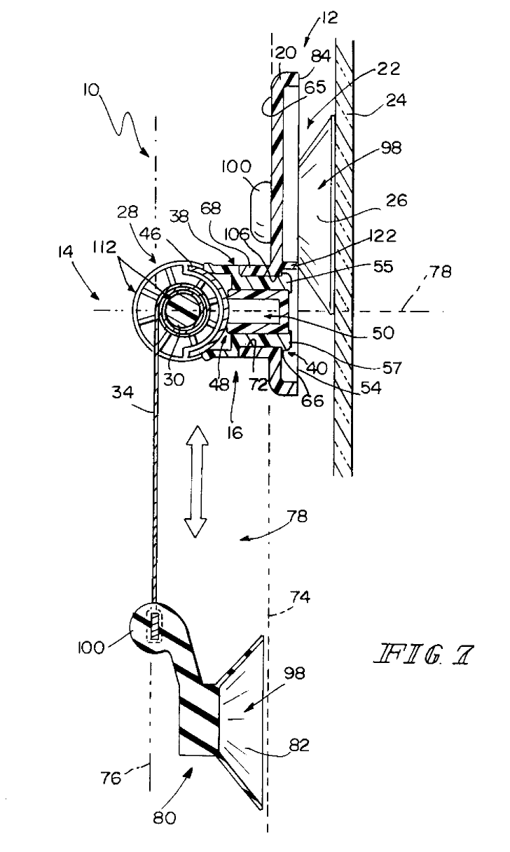

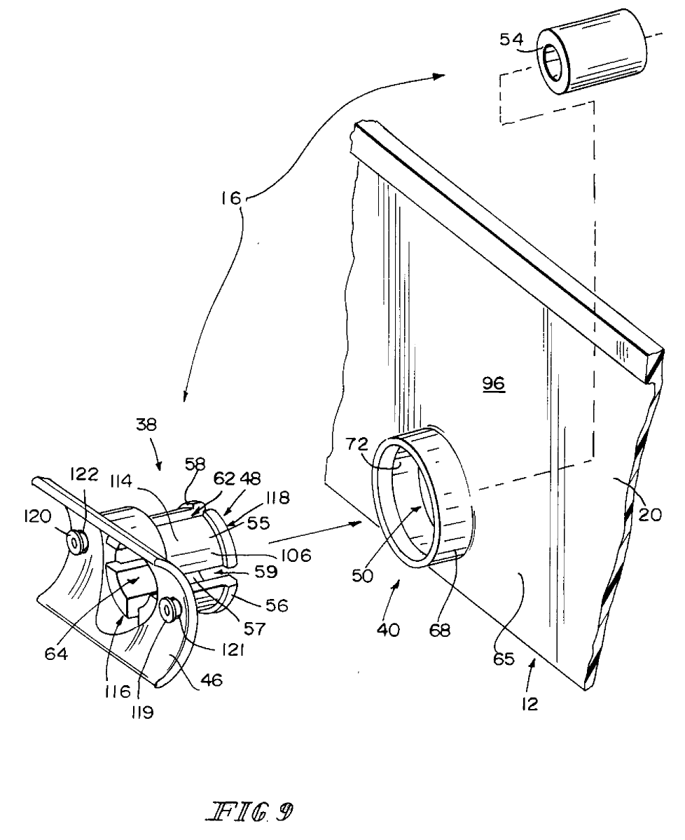

Swivel 16, shown in FIGS. 8 and 9, includes a shade pivot 38 and a pivot retainer 54. Shade pivot 38 is coupled to lower shade 12 and arranged to extend into and lie in rotative bearing engagement with a pivot receiver 40 formed in window-cover plate 20. Pivot receiver 40 is configured to support shade pivot 38 during rotation of upper shade 12 in either a counter-clockwise direction 42 (FIGS. 2 and 5) or a clockwise direction 44 (FIG. 6). Pivot axis 18 extends perpendicularly through both pivot receiver 40 and shade pivot 38.

Shade pivot 38, as shown in FIGS. 7-9, includes an axle-support plate 46 coupled to lower shade 14 and an axle 48 coupled to axle-support plate 46. Axle 48 is arranged to extend into an axle-receiver passageway 50 defined by pivot receiver 40. Axle 48 is further configured to mate with a flange 52 included in window-cover plate 20 and as shown in FIG. 8. Shade pivot 38 cooperates with window-cover plate 20 to cause lower shade 14 to rotate about pivot axis 18 in a generally vertical plane as suggested by FIG. 7.

As shown in FIG. 7, window-cover plate 20 is formed to include a first side 65 and an opposite second side 66. First side 65 is arranged to face toward lower shade 14 and lie in spaced-apart relation to oppositely facing second side 65. An axle support ring 68, included in pivot receiver 40, is appended to first side 65 and configured to extend toward lower shade 14 to support shade pivot 38. A lip-guard wall 122, also included in pivot receiver 40, is shown in FIG. 8 and is appended to second side 66 as well as configured to extend away from lower shade 14 to block inadvertent contact with axle 48.

Pivot retainer 54, as shown in FIG. 7, is included in swivel 16 and is coupled to axle 48. Pivot retainer 54 is arranged to provide means for moving axle 48 relative to axle-support plate 46 while axle 48 lies in axle-receiver passageway 50. Axle-receiver passageway 50 is defined by a cylindrical bearing surface 72 illustrated in FIGS. 8 and 9. Pivot retainer 54 operates to keep axle 48 in contact with cylindrical bearing surface 72.

Axle 48 is designed so that assembly of lower shade 14 to upper shade 12 may be completed without the use of tools. In illustrative embodiments, axle 48 is inserted along pivot axis 18 through axle-receiver passageway 50 to form a snap-fit attachment to window-cover plate 20. Snap-fit attachment is caused by axle 48 being formed of multiple spaced-apart journal posts 55, 56, 57, 58 as shown in FIG. 8.

As shown in FIG. 8, axle 48 illustratively includes four journal posts 55, 56, 57, 58 positioned to lie circumferentially spaced-apart to one another. Journal posts 55, 56, 57, 58 cooperate to define a pivot-retainer space 64 therebetween in which pivot retainer 54 is positioned after axle 48 passes through pivot-receiver passageway 50. Pivot-retainer space 64 is sized to receive pivot retainer 54 so that pivot retainer 54 prevents deflection of journal posts 55, 56, 57, 58 inwardly toward pivot axis 18 as suggested in FIG. 7.

Journal post 55 is capable of moving radially relative to journal posts 56, 57, 58 because of post-deflection channels 59, 62. As shown in FIG. 9, first journal post 55 is positioned to lie in spaced-apart relation to second journal post 56 to define a first post-deflection channel 59 therebetween. Substantially similar post-deflection channels 60, 61, 62 are also defined between second and third journal posts 56, 57, third and fourth journal pots 57, 58, and fourth and first journal posts 55, 58.

As axle 48 passes through axle-receiver passageway 50 formed in window-cover plate 20, journal posts 55, 56, 57, 58 are moved toward pivot axis 18 so that axle 48 may pass through axle-receiver passageway 50 until a lip 70, included in journal posts 55, 56, 57, 58, comes into contact with flange 52. As shown in FIGS. 7-9, lip 70 is arranged to lie in spaced-apart relation to axle-support plate 46 and is configured to mate with flange 52 on second side 66 of window-cover plate 20. Lip 70 operates to keep axle 48 in rotative bearing engagement with cylindrical bearing surface 72, formed in window-cover plate 20.

First journal post 55 is substantially the same as second, third, and fourth journal posts 56, 57, 58, and therefore, only first journal post 55 will be discussed in detail. First journal post 55 includes lip 70 and a leg 114 as illustrated in FIGS. 7-9. Leg 114 is arranged to extend away from axle-support plate 46 toward window-cover plate 20 parallel to pivot axis 18. Leg 114 has a mount end 116 and a free end 118. Mount end 116 of leg 114 is appended to axle-support plate. Lip 70 is appended to an outer surface of free end 118 of leg 114 and arranged to extend in a radically outward direction as shown in FIG. 7.

Journal posts 55, 56, 57, 58 cooperate to form a journal contact surface 106 which cooperates with cylindrical bearing surface 72 to promote smooth and controlled rotation of window-cover plate 20 relative to lower shade 14. Cylindrical bearing surface 72 of pivot receiver 40 is positioned to lie in spaced-apart relation pivot axis 18 a first distance and is arranged to face toward pivot axis 18 as shown in FIG. 7. Journal-contact surface 106 is positioned to lie in spaced-apart relation to pivot axis 18 a second distance and is arranged to face away from the pivot axis 18 toward cylindrical bearing surface 72. Journal contact surface 106 is constrained to lie in confronting relation to cylindrical bearing surface 72 as suggested in FIG. 7.

Axle 48, included in swivel 16, is coupled to pin-support frame 28 of lower shade 14 to move with lower shade 14 via axle-support plate 46. As shown in FIG. 3, axle-support plate 46 is coupled to pin-support frame 28 by first and second fasteners 119, 120. First and second fasteners 119, 120 extend through companion fastener apertures 121, 122 formed in axle-support plate 46. In illustrative embodiments, first and second fasteners 119, 120 are rivets, but may be any suitable alternative.

Before multi-shade vehicle window cover 10 is installed in vehicle window 24, lower shade 14 may be arranged so that mat-support pin 30 is configured to extend in a generally horizontal direction and window-cover plate 20 is configured to extend in a generally horizontal direction to assume an initial position as illustrated in FIG. 4. Swivel 16 interconnects window-cover plate 20 and pin-support frame 28 so that window-cover plate 20 may move from the initial position to a tilted position as shown in FIGS. 5 and 6.

Window-cover plate 20 may be rotated in counter-clockwise direction 42 to assume a first tilted position as shown in FIG. 5. When window-cover plate 20 is in first tilted position, window-cover plate 20 is oriented to lie in a positively sloping orientation relative to mat-support pin 30. In the alternate, window-cover plate 20 may also be rotated in clockwise direction 44 to establish a second tilted position in which window-cover plate 20 is oriented to lie in a negatively sloping orientation relative to mat-support pin 30 as shown in FIG. 6.

The various components of multi-shade vehicle window cover 10 may be viewed in relation to generally vertical planes define by components which substantially lie therein. As illustrated in FIG. 7, window-cover plate 20 is positioned to lie in a first plane 74 while pliable window-cover mat 34 is positioned to lie in a second plane 76 after movement of pliable window-cover mat 34 to the unrolled use position illustrated in FIG. 2. Swivel 16 is positioned to lie a space 78 provided between first and second planes 74, 76. Pivot axis 18 is defined to lie in a substantially perpendicular relation to first and second planes 74, 76.

As illustrated in FIG. 7, multiple component positions may be defined by their position relative to space 78. Illustratively, first and second suction cups 25, 26 of anchor means 22 are positioned to lie outside space 78. Third suction cup 82 of tether means 80 is arranged to lie within space 78 when pliable window-cover mat 34 is in unrolled use position.

Window-cover plate 20 of upper shade 12 is coupled illustratively to vehicle window 24 to cause an upper edge 84 of window-cover plate 20 to lie alongside and extend along an elongated top portion 86 of a window frame 88 bordering vehicle window 24 as illustrated in FIG. 2. Window-cover plate 24 is positioned so that upper shade 12 covers a gap 90 located between lower shade 14 and elongated top portion 86 of window frame 88.

As shown in FIG. 5, upper edge 84 of window-cover plate 20 is positioned to have a positively sloping orientation relative to generally horizontal mat-support pin 30. Upper edge 84 and mat-support pin 30 cooperate to define a first acute angle 102 therebetween. As shown in FIG. 6, window-cover plate 20 may be positioned to cause upper edge 84 to have a negatively sloping orientation relative to mat-support pin 30. Upper edge 84 and mat-support pin 30 cooperate to define a second acute angle 104 therebetween.

Window-cover plate 20 may be further specified by dividing window-cover plate into three sections, a right-side section 92, a left-side section 94, and a center section 96 positioned to lie between right-side section 92 and left-side section 94 as shown in FIGS. 1 and 3. First suction cup 25 of anchor means 22 is coupled to right-side section 92 while second suction cup 26 is coupled to left-side section 94. Swivel 16 is coupled to center section 96 and arranged to lie in spaced-apart relation to first and second suction cups 25, 26. In other illustrative embodiments, window-cover plate 20 may be coupled to vehicle window 24 by a cover-plate anchor 108 also including first and second suction cups 25, 26.

Suction cups 25, 26, 82 are further defined by their arrangement relative to upper shade 12 and lower shade 14 as well as their positional relationship to space 78. Suction cups 25, 26, 82 each include an open suction chamber 98 and a cup retainer 100 as shown in FIGS. 1, 3, and 7. Open suction chamber 98 is arranged to face in a first direction away from lower shade 14. Swivel 16 is arranged to extend in opposite second direction parallel to pivot axis 18 and away from window-cover plate 20. As shown in FIG. 7, cup retainer 100 of first and second suction cups 25, 26 is positioned to lie within space 78 between first and second planes 74, 76. Illustratively, cup retainer 100 passes through a cup-retainer aperture 110 formed in window-cover plate 20.

Multi-shade vehicle window cover 10 is useful for covering vehicle windows such as vehicle window 24 shown in FIG. 2. Vehicle window 24 has a generally horizontal bottom side, a generally vertical right side, a generally vertical left side, and an angled top side relative to the bottom side. Lower shade 14 is suited for covering the rectangular portion of vehicle window 24. Upper shade 12 may be rotated relative to lower shade 14 so that upper edge 84 of upper shade 12 is positioned near and along the angled edge of the vehicle window.

Vehicle windows are configured with varying shapes and angles of their upper edges. Multi-shade vehicle window cover 10 is well suited to covering various vehicle windows because upper shade 12 can be configured to cover various sized and shaped gaps (like gap 90) found between lower shade 14 and top portion 86 of window frame 88. Upper shade functions to block light from coming through gap 90 and into eyes 124 of juvenile 126 as shown in FIG. 2.

1. A multi-shade vehicle window cover comprising
an upper shade,
a lower shade, and
a swivel coupled to the upper shade and to the lower shade and configured to support the lower shade for pivotable movement relative to the upper shade about a pivot axis.

2. The multi-shade vehicle window cover of claim 1, wherein the upper shade includes a window-cover plate and the lower shade includes a pin-support frame coupled to the swivel, a mat-support pin mounted on the pin-support frame for rotation about an axis of rotation, and a pliable window-cover mat coupled to the mat-support pin for movement between a rolled storage position wound about the mat-support pin and an unrolled use position arranged to hang downwardly from the mat-support pin in a direction extending away from the upper shade to cooperate with the window-cover plate of the upper shade to create an expanded sun shield.

3. The multi-shade vehicle window cover of claim 2, wherein the mat-support pin of the lower shade is arranged to extend in a generally horizontal direction and the window-cover plate of the upper shade is arranged to extend in a generally horizontal direction to assume an initial position relative to the mat-support pin of the lower shade and is coupled to the swivel for pivotable movement about the pivot axis from the initial position in one of a counter-clockwise direction to assume a first tilted position in which the window-cover plate is oriented to lie in a positively sloping orientation relative to the mat-support pin and a clockwise direction to assume a second tilted position in which the window-cover plate is oriented to lie in a negatively sloping orientation relative to the mat-support pin.

4. The multi-shade vehicle window cover of claim 3, wherein the window-cover plate is arranged to lie in a first plane, the pliable window-cover mat is arranged to lie in a second plane upon movement of the pliable window-cover mat to assume the unrolled use position and the swivel is arranged to lie in a space provided between the first and second planes to cause the pivot axis to lie in a substantially perpendicular relation to each of the first and second planes.

5. The multi-shade vehicle window cover of claim 4, further comprising anchor means for anchoring the window-cover plate to a vehicle window and wherein the anchor means includes a suction cup arranged to lie outside the space provided between the first and second planes.

6. The multi-shade vehicle window cover of claim 4, further comprising tether means for tethering a lower end of the pliable window-cover mat to a vehicle window upon movement of the pliable window-cover mat to assume the unrolled use position and wherein the tether means includes a suction cup arranged to lie in the space provided between the first and second planes.

7. The multi-shade vehicle window cover of claim 6, further comprising anchor means for anchoring the window-cover plate to a vehicle window and wherein the anchor means includes a suction cup arranged to lie outside the space provided between the first and second planes.

8. The multi-shade vehicle window cover of claim 1, wherein the upper shade includes a window-cover plate coupled to the swivel and anchor means for anchoring the window-cover plate to a vehicle window to cause an upper edge of the window-cover plate to lie alongside and extend along an elongated top portion of a window frame bordering the vehicle window so that the window-cover plate of the upper shade covers a gap located between the lower shade and the elongated top portion of the window frame.

9. The multi-shade vehicle window cover of claim 8, wherein the window-cover plate includes a left-side section, a right-side section, and a center section located between the left-side and right-side sections, the anchor means includes a first suction cup coupled to the right-side section and a second suction cup coupled to the left-side section, and the swivel is coupled to the center section and arranged to lie in between and in spaced-apart relation to each of the first and second suction cups.

10. The multi-shade vehicle window cover of claim 8, wherein the anchor means includes a suction cup coupled to the window-cover plate and configured to include an open suction chamber arranged to face in a first direction away from the lower shade and the swivel is arranged to extend in an opposite second direction away from the window-cover plate of the upper shade.

11. The multi-shade vehicle window cover of claim 8, wherein the lower shade includes a pin-support frame coupled to the swivel and formed to include a top edge, a mat-support pin mounted on the pin-support frame for rotation about an axis of rotation, and a pliable window-cover mat coupled to the mat-support pin for movement between a rolled storage position wound about the mat-support pin and an unrolled use position arranged to hang downwardly from the mat-support pin in a direction extending away from the upper shade to cooperate with the window-cover plate of the upper shield to create an expanded sun shield and the pliable window-cover mat is arranged to extend downwardly away from the top edge when moved to assume the unrolled use position and the top edge of the pin-support frame of the lower shade cooperates with the upper edge of the window-cover plate of the upper shade to define an acute included angle therebetween in response to pivoting movement of the pin-support frame of the lower shade relative to the upper shade to assume a substantially horizontal position.

12. The multi-shade vehicle window cover of claim 1, wherein the upper shade is formed to include a pivot receiver and the swivel includes a shade pivot coupled to the lower shade and arranged to extend into and lie in rotative bearing engagement with the pivot receiver formed in the upper shade to support the shade pivot for rotation about the pivot axis.

13. The multi-shade vehicle window cover of claim 12, wherein the upper shade includes a window-cover plate having a first side facing toward the lower shade and an opposite second side facing away from the lower shade, the pivot receiver includes an axle-support ring appended to the first side and extending toward the lower shade to support the shade pivot.

14. The multi-shade vehicle window cover of claim 12, wherein the shade pivot includes an axle-support plate coupled to the lower shade and an axle coupled to the axle-support plate and extending into an axle-receiver passageway defined by the pivot receiver to mate with a flange included in the upper shade.

15. The multi-shade vehicle window cover of claim 14, wherein the axle includes at least two journal posts positioned to lie circumferentially spaced-apart to one another and the first journal post is positioned to lie in spaced-apart relation to the second journal post to define a pivot-retainer space therebetween.

16. The multi-shade vehicle window cover of claim 14, wherein the upper shade includes a window-cover plate having a first side facing toward the lower shade and an opposite second side facing away from the lower shade and the swivel further includes a pivot retainer coupled to the axle and arranged to provide means for moving the axle relative to the axle-support plate while the axle lies in the axle-receiver passageway to cause a lip included in the axle and arranged to lie in a spaced-apart relation to the axle support plate to mate with the flange on the second side of the window-cover plate to retain the axle in the axle-receiver passageway in rotative-bearing engagement with a cylindrical bearing surface formed in the window-cover plate to define the axle-receiver passageway.

17. A multi-shade vehicle window cover comprising
an upper shade including a window-cover plate and anchor means for coupling the window-cover plate to a vehicle window so that the window-cover plate is oriented to lie in positively sloping orientation relative to ground and
a window cover coupled to and configured to move relative to the window-cover plate to assume a generally horizontal position and the window cover extends in a downward direction away from the upper shade to cooperate with the window-cover plate of the upper shade to form an expanded sun shield.

18. The multi-shade vehicle window cover of claim 17, wherein the window cover includes a lower shade and a swivel interconnecting the lower shade to the upper shade.

19. The multi-shade vehicle window cover of claim 18, wherein the lower shade includes a pin-support frame coupled to the swivel, a mat-support pin mounted on the pin-support frame for rotation about an axis of rotation, and a pliable window-cover mat coupled to the mat-support pin for movement between a rolled storage position wound about the mat-support pin and an unrolled use position arranged to hang in the downward direction extending away from the upper shade.

20. The multi-shade vehicle window cover of claim 19, wherein the window-cover plate includes an upper edge having a positively sloping orientation relative to the generally horizontal mat-support pin and the mat-support pin and the upper edge of the window-cover plate cooperate to define a first acute angle therebetween.

21. The multi-shade vehicle window cover of claim 18, wherein the upper shade is formed to include a pivot receiver and the swivel includes a shade pivot coupled to the lower shade and arranged to extend into and lie in rotative bearing engagement with the pivot receiver formed in the upper shade.

22. The multi-shade vehicle window cover of claim 21, wherein the pivot receiver includes a cylindrical bearing surface positioned to lie in space-apart relation to a pivot axis a first distance and is arranged to face toward the pivot axis, the shade pivot includes a journal-contact surface positioned to lie in spaced-apart relation to the pivot axis a second distance and is arranged to face away from the pivot axis, and the journal-contact surface of the shade pivot is constrained to lie in confronting relation to the cylindrical bearing surface.

23. The multi-shade vehicle window cover of claim 17, where the window-cover plate includes a left-side section, a right-side section, and a center section located between the left-side and right-side sections and the anchor means includes a first suction cup coupled to the right-side section and a second suction cup coupled to the left-side section.

24. The multi-shade vehicle window cover of claim 23, wherein the window cover includes a pliable window-cover mat and tether means for tethering a lower end of the pliable window-cover mat to a vehicle window upon movement of the pliable window-cover mat to assume an unrolled use position and the tether means includes a third suction cup positioned to lie in spaced-apart relation to the first and second suction cups when the window-cover mat is in the unrolled use position.

25. A multi-shade vehicle window cover comprising
an upper shade including a window-cover plate and a cover-plate anchor adapted to couple the window-cover plate to the a vehicle window, the cover-plate anchor includes a suction cup positioned to lie between the window-cover plate and the vehicle window and a cup retainer is configured to pass through a cup-retainer aperture formed in the window-cover plate to couple the suction cup to the window-cover plate,
a lower shade including a mat mount, a pliable window-cover mat coupled to a mount-support pin included in the mat mount for movement between a rolled storage position wound about the mat-support pin and an unrolled use position arranged to hang in a downward direction away from the upper shade, and a mat tether coupled to a lower end of the pliable window-cover mat to interconnect the lower end of the pliable window-cover mat to a lower portion of a vehicle window upon movement of the pliable window-cover mat to assume the unrolled use position, and
a swivel coupled to the upper shade and the lower shade and configured to support the lower shade for pivotable movement relative to the upper shade about a pivot axis, the swivel includes a shade pivot coupled to the lower shade and arranged to extend along the pivot axis into a pivot receiver formed in the window-cover plate and a pivot retainer is positioned to lie within a pivot-retainer space formed in an axle of the shade pivot, the axle is positioned to lie along the pivot axis and is located between the pivot retainer and the pivot receiver.
